(19) United States
(12) Patent Application Publication
(10) Pub. No.: US 2026/0030073 A1
(43) Pub. Date: Jan. 29, 2026

(54) Daily Spending Limit Increase Enforcement

(71) Applicant: Oracle International Corporation, Redwood Shores, CA (US)

(72) Inventors: Alexandru Munteanu, Seattle, WA (US); Prabhjot Singh, Monroe, WA (US); Marek Czajka, Austin, TX (US); Brian Feinstein, Redmond, WA (US); Rohit Shamasundara Shetty, Apex, NC (US)

(73) Assignee: Oracle International Corporation, Redwood Shores, CA (US)

(21) Appl. No.: 18/781,740

(22) Filed: Jul. 23, 2024

(51) Int. Cl. G06F 9/50

(52) U.S. Cl. CPC G06F 9/5077; G06F 9/5072; G06F 2209/5011; G06F 2209/5022; G06F 2209/504; G06F 2209/506; G06F 2209/508

(57) ABSTRACT

Techniques for spending limits in a cloud computing network are disclosed. The system receives a usage request in a cloud computing network for a user. The user having a customer tenancy in the cloud computing network including cloud computing resources. The system determines a cloud computing usage increase value relative to a time frame (such as a day) using at least the usage request. The system determines whether the cloud computing usage increase value exceeds a threshold. Based on determining that the cloud computing usage increase value exceeds the threshold, the system performs a remediation action. The remediation action comprises at least one of rejecting the usage request and bypassing the threshold.

### TECHNICAL FIELD

The present disclosure relates to computing systems. In particular, the present disclosure relates to usage limits for cloud computing systems.

### BACKGROUND

Cloud computing involves the provision of computing services, including data storage and processing power, via the internet. A cloud computing system enables users to access these resources on demand without requiring direct active management. The system allocates and manages resources across multiple data centers, ensuring high availability and redundancy.

By distributing functions across geographically dispersed locations, a cloud computing system enhances performance and reliability. The system dynamically allocates resources based on real-time demand, optimizing efficiency and reducing operational costs. Users benefit from the flexibility to scale their operations up or down as needed, with the system adjusting resources to maintain optimal performance.

In cloud computing, the system tracks resource usage, generating detailed reports and billing statements for transparency and accuracy. Cloud computing encourages efficient resource use and provides users with a clear understanding of their consumption and costs. The system's comprehensive management of computing services through the internet defines cloud computing as a scalable, flexible, and cost-effective solution for modern enterprises.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 is a diagram that illustrates a system in accordance with one or more embodiments;

FIG. 7 is a flow chart that illustrates an example set of operations for determining a threshold for spending limit increase enforcement in accordance with one or more embodiments;

FIG. 8 is a flow chart that illustrates another example set of operations for determining a threshold for spending limit increase enforcement in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present invention.
1. GENERAL OVERVIEW
2. CLOUD COMPUTING TECHNOLOGY
3. COMPUTER SYSTEM
4. SPENDING LIMIT INCREASE ENFORCEMENT ARCHITECTURE
5. DETERMINING REMEDIATION ACTION FOR SPENDING LIMIT INCREASE ENFORCEMENT
6. DETERMINING THRESHOLD FOR SPENDING LIMIT INCREASE ENFORCEMENT
7. PRACTICAL APPLICATIONS, ADVANTAGES & IMPROVEMENTS
8. MISCELLANEOUS; EXTENSIONS

### 1. General Overview

Techniques for enforcing resource usage increase limits in a cloud computing network are disclosed. The resource usage increase limits allow rapid resource usage increases to be detected and remediated. The resource usage increase limits restricts the increase of cloud computing resource use within a time period, such as a day. Such a resource usage increase limit is distinct from a fixed usage limit such as a monthly usage limit that concerns a total limit rather than an increase limit.

One or more embodiments include determining if a cloud computing usage increase value exceeds a threshold. The cloud computing cloud computing usage increase is calculated from new resource requests and resource deletions within a time period such as a day. The threshold may be fixed value or a function of the monthly limit.

One or more embodiments include performing a remediation action if the cloud computing usage increase value exceeds the threshold. Exemplary remediation actions include rejecting the usage request and bypassing the threshold.

One or more embodiments is a system for managing cloud computing resources for a customer. The system includes calculations for daily usage limits, thresholds, and cost estimates. The system receives usage requests, determines if the daily increase exceeds the threshold, and performs corresponding operations, such as remediation actions. The system also maintains a table of new and deleted computing resource requests. The system calculates daily usage by considering new resource requests and deleted resources. The system sends warnings to the customer if the usage increase exceeds the threshold and rejects requests if necessary.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling Operating System (OS), middleware, and/or application deployment e.g., on self-service virtual machines that can be spun up on demand.

In some examples, IaaS provisioning may refer to acquiring computers or virtual hosts for use and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. In some instances, the provisioning can be done manually, a provisioning tool may be utilized to provision the resources, and/or deployment tools may be utilized to deploy the code once the infrastructure is provisioned.

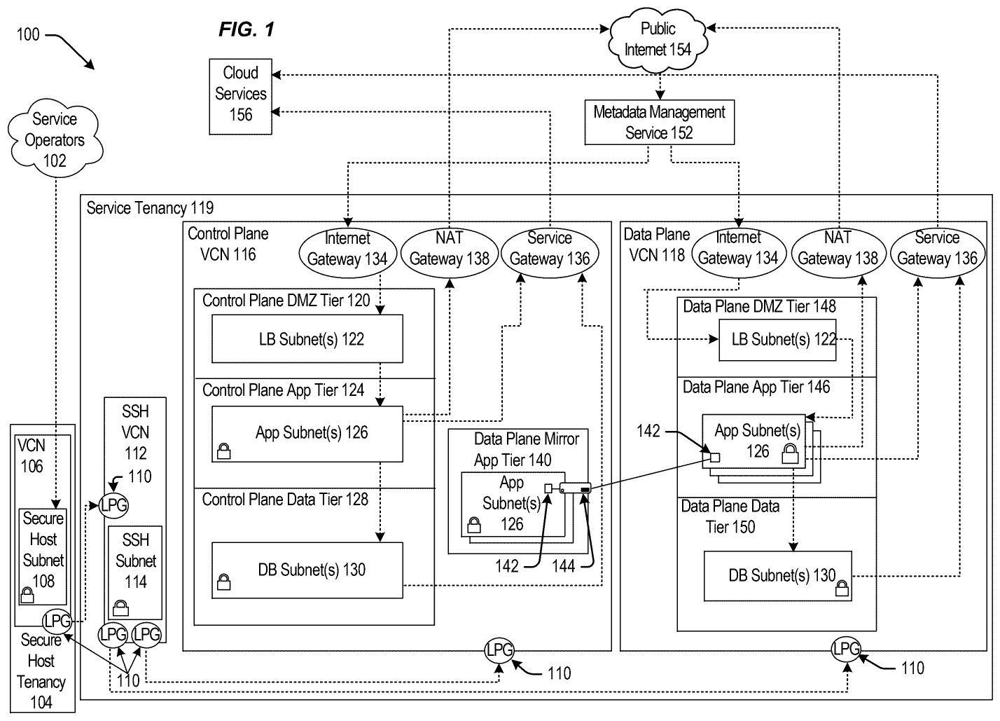

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices that may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124. The LB subnet(s) 122 may further be communicatively coupled to an Internet gateway 134 that can be contained in the control plane VCN 116. The app subnet(s) 126 can be communicatively coupled to the DB subnet(s) 130 contained in the control plane data tier 128, a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The service gateway 136 can make API calls to cloud services 156, and cloud services 156 can send requested data to the service gateway 136.

In some examples, the secure host tenancy 104 can be directly connected to the service tenancy 119 that may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118. The data plane mirror app tier 140 of the control plane VCN 116 can communicate with the data plane app tier 146 of the data plane VCN 118 via VNICs 142. VNICs 142 can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configurations of resources contained in the data plane VCN 118.

In some embodiments, the control plane VCN 116 and the data plane VCN 118 can be contained in the service tenancy 119. The user, or the customer, of the system may be restricted from owning or operating either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users' or other customers' resources. Also, this embodiment may allow users or customers of the system to store databases privately without needing to rely on public Internet 154 that may not have a desired level of threat prevention for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119 that may be isolated from public Internet 154.

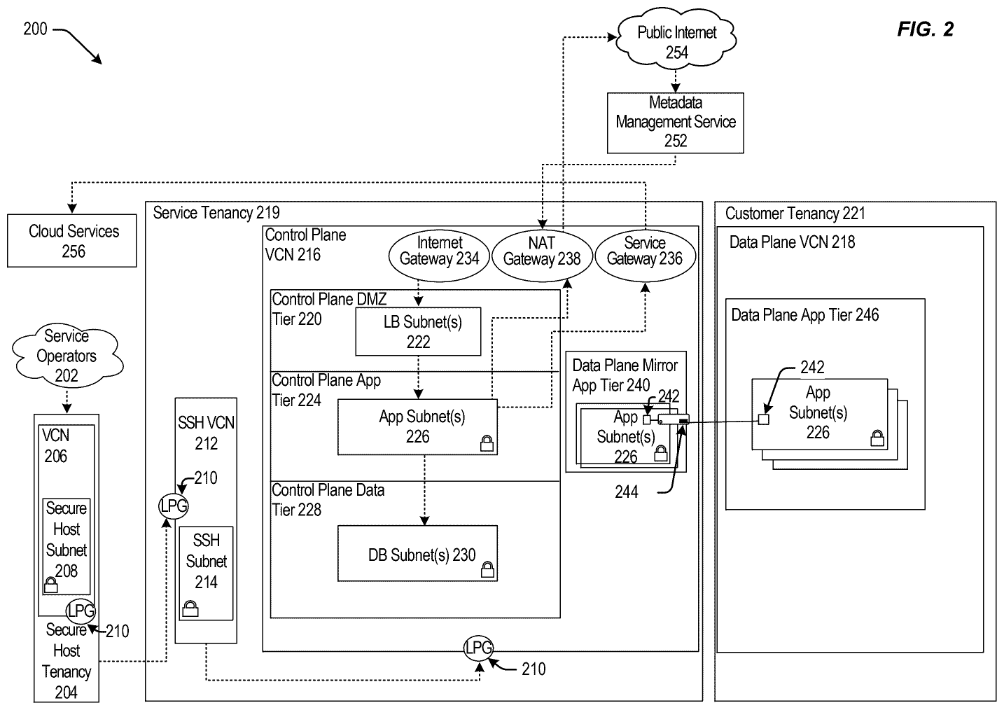

FIG. 2 is a block diagram illustrating another example pattern of an IaaS architecture 200, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1). The Internet gateway 234 can be contained in the control plane VCN 216. Additionally, the app subnet(s) 226 can be communicatively coupled to the DB subnet(s) 230 contained in the control plane data tier 228, a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216, contained in the service tenancy 219, and the data plane VCN 218, contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in Region 1, and cloud service Deployment 1 may be located in Region 1 and in Region 2. If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

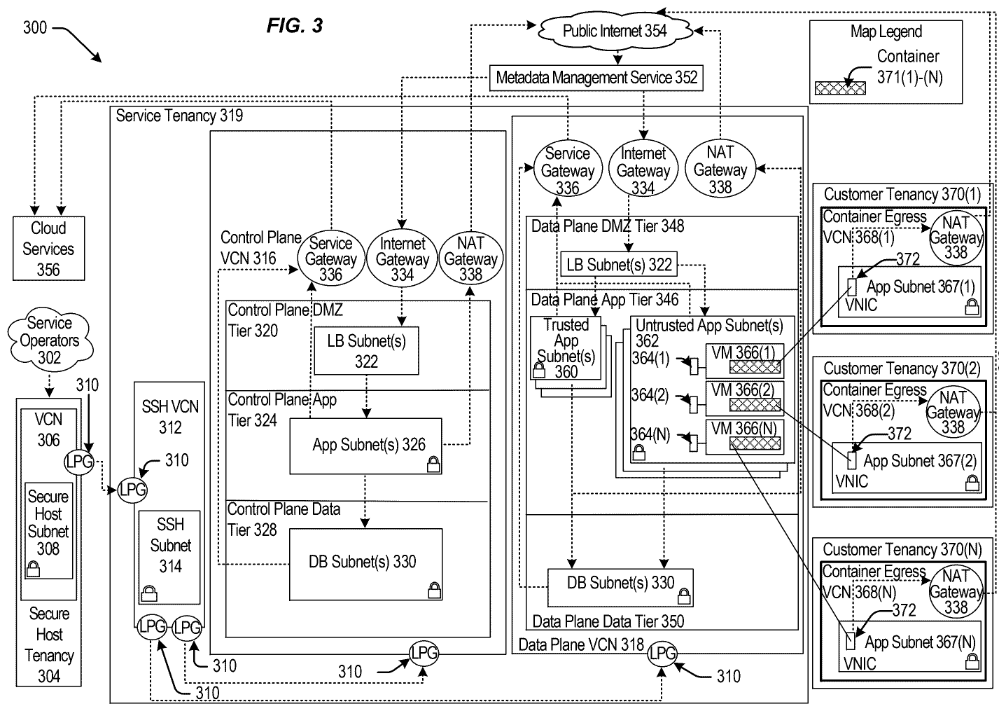

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316. Additionally, the app subnet(s) 326 can be communicatively coupled to the DB subnet(s) 330 contained in the control plane data tier 328, to a service gateway 336 (e.g., the service gateway of FIG. 1), and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code, where the containers 381(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

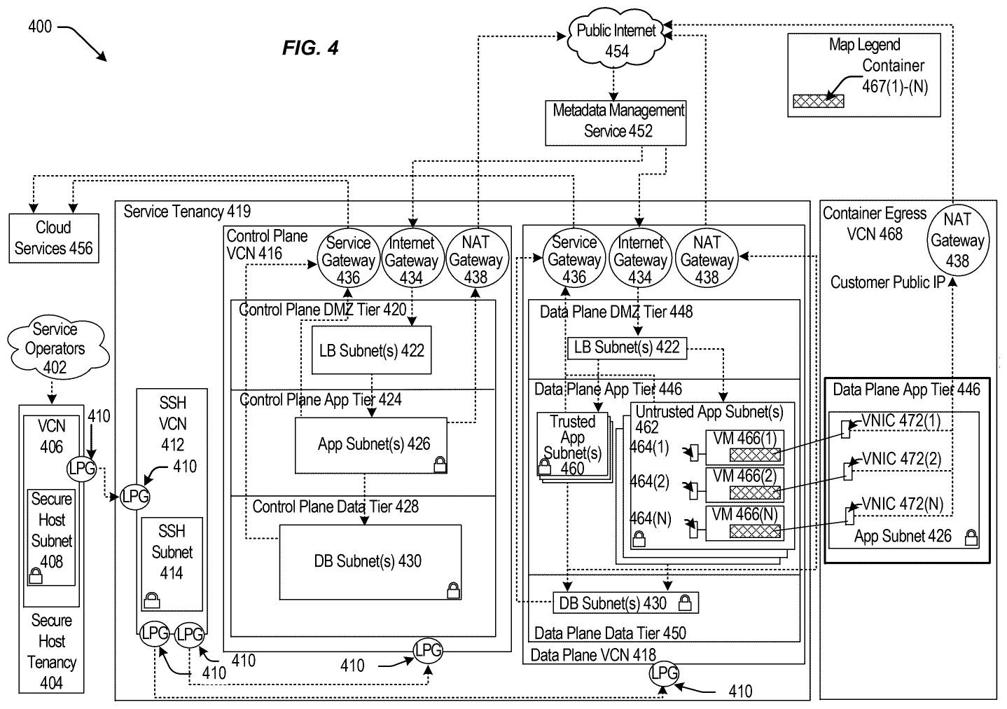

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1). The SSH VCN 412 can be communicatively coupled to a control plane VCN 416 (e.g., the control plane VCN 116 of FIG. 1) via an LPG 410 contained in the control plane VCN 416. The SSH VCN 412 can be communicatively coupled to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424. The LB subnet(s) 422 can be communicatively coupled to an Internet gateway 434 (e.g., the Internet gateway 134 of FIG. 1) that can be contained in the control plane VCN 416. The app subnet(s) 426 can be communicatively coupled to the DB subnet(s) 430 contained in the control plane data tier 428, a service gateway 436 (e.g., the service gateway of FIG. 1), and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3. The pattern illustrated by the architecture of block diagram 400 of FIG. 4 may be implemented for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467 (1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use the same network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset stored by the computer network is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates the tenants that have authorization to access an application. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. Computer System

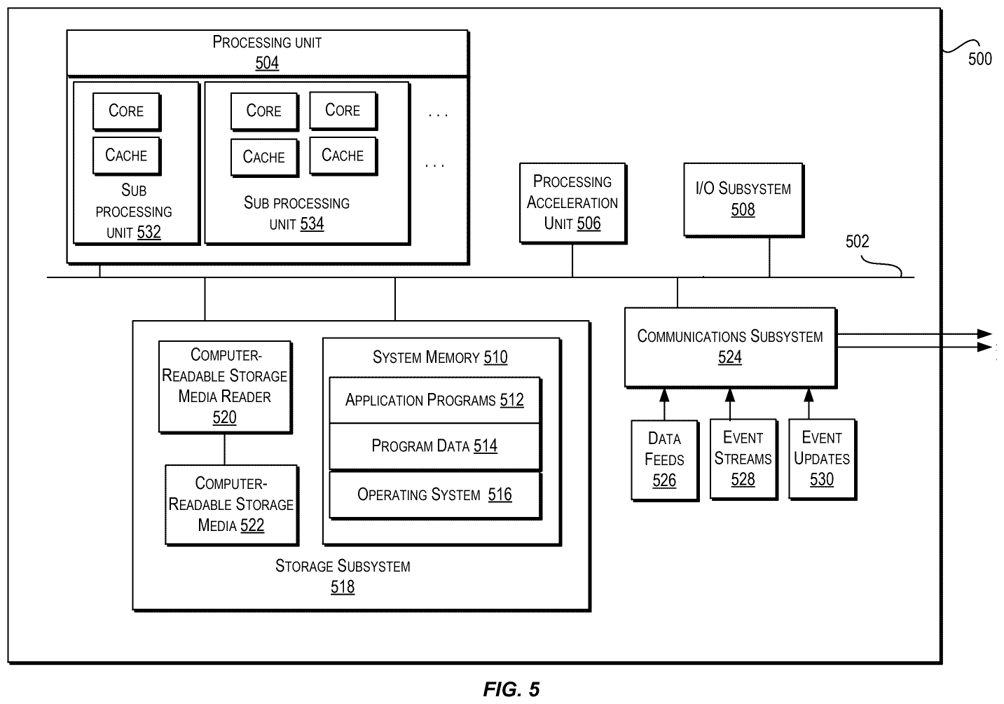

FIG. 5 illustrates an example computer system 500, where various embodiments may be implemented. The system 500 may be used to implement any of the computer systems described above. As shown in FIG. 5, computer system 500 includes a processing unit 504 that communicates with several peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The PCI bus can be implemented as a Mezzanine bus manufactured to the IEEE P1386.1 standard.

Processing unit 504 that can be implemented as one or more integrated circuits (e.g., a conventional microprocessor or microcontroller) controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some of the program code to be executed can be resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator) through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 500 may comprise a storage subsystem 518 that provides a tangible, non-transitory, computer-readable storage medium for storing software and data constructs that provide the functionality of the embodiments described in this disclosure. The software can include programs, code modules, instructions, scripts, etc., that when executed by one or more cores or processors of processing unit 504, provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations, where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams that may include event streams 528 of real-time events and/or event updates 530 that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended only as a specific example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Speeding Limit Increase Enforcement Architecture

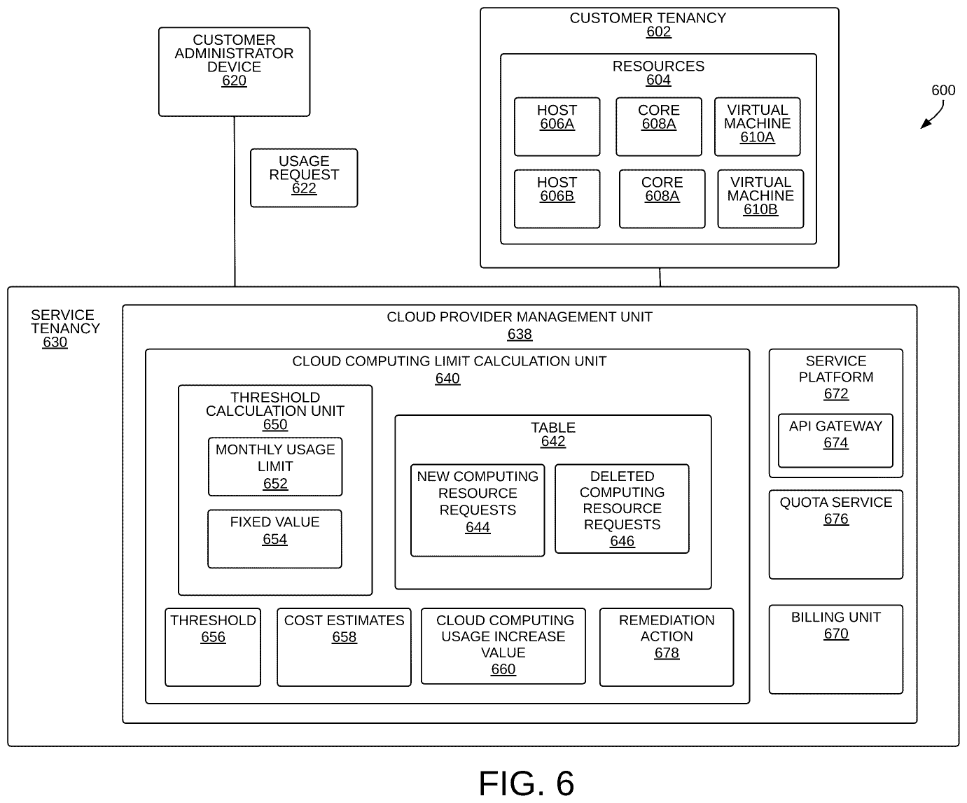

FIG. 6 illustrates a system 600 in accordance with one or more embodiments. As illustrated in FIG. 6, system 600 includes customer tenancy 602, resources 604 including hosts 606A and 606B, cores 608A and 608B, virtual machines 610A and 610B, customer administrator device 620, .usage request 622, service tenancy 630, cloud provider management unit 638, cloud computing limit calculation unit 640, threshold calculation unit 650, monthly usage limit 652, fixed value 654, table 642 with new computing resource requests 644 and deleted computing resource requests 646, threshold 656, cost estimates 658, cloud computing usage increase value 660, remediation action 678, billing unit 670, service platform 672, quota service 676 and API gateway 674.

In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In accordance with an embodiment, a tenancy is a secure and isolated partition within a cloud system that allows a tenant to create, organize, and administer their cloud resources. In one or more embodiments, a tenancy is a hierarchical collection of compartments, where the root compartment is the tenancy. A tenant, or customer, is a party with a tenancy in the cloud system. A cloud system includes multiple tenancies that are isolated from one another other. A cloud network manager is the manager for one or more tenants or customers in a cloud network, such as an owner or renter of the cloud network.

In accordance with an embodiment, service tenancy 630 is a tenancy under the control of the cloud network manager. Components in service tenancies are under the control of the cloud network manager. Furthermore, the components in the service tenancies are protected using cloud network security.

In accordance with an embodiment, customer tenancy 602 is a tenancy under the control of the customer. Customer tenancy 602 defines a customer network. Customer tenancy 602 is a secure and isolated partition where users create, organize, and administer cloud resources. The resources span various services, including compute instances, networks, storage, databases, identity management, and analytics. Customer tenancy 602 is a logical boundary within the cloud computing system that provides a way to segregate and manage resources for different purposes or different groups within an organization. Each tenancy operates independently, ensuring data isolation and security. Customer tenancy 602 is isolated from other tenancies, preventing unauthorized access or data leakage. Within customer tenancy 602, users create and manage various resources, such as virtual machines, storage volumes, and networking components. Customer tenancy 602 allows users to define policies, manage users, and control access to resources.

In accordance with an embodiment, customer tenancy 602 includes resources 604. In FIG. 4, Resources 604 includes hosts 606A and 606B, cores 608A and 608B, and virtual machines 610A and 610B. Resources 604 are assigned to the customer tenancy 602 and may be the subject of monitoring by billing unit 670.

In accordance with an embodiment, hosts 606A and 606B are dedicated physical servers, also known as bare-metal servers, dedicated to customer tenancy 602. Hosts 606A and 606B are assigned to customer tenancy 602 for the customer network.

In accordance with an embodiment, cores 608A and 608B are physical processing units, such as within a central processing unit (CPU). Cores are computational engines responsible for executing instructions. Cores 608A and 608B handle tasks such as arithmetic operations, logic, and data movement. Modern CPUs often have multiple cores to enhance parallel processing. In cloud computing, cores 608A and 608B are located at physical servers (hosts) and shared among virtual machines running on those hosts.

In accordance with an embodiment, virtual machines 610A and 610B are the virtualization or emulation of a computer system. Virtual machines 610A and 610B are based on computer architectures and provide the functionality of a physical computer. One or more virtual “guest” virtual machines run on a physical “host” machine. Each virtual machine runs its own operating system and functions separately from the other virtual machines, even when the virtual machines are all running on the same host.

In accordance with an embodiment, customer administrator device 620 is a computer device that is used to administer computer networks at customer tenancy 602. Customer administrator device 620 is any type of computing device such as laptop, desktop, or portable device. Customer administrator device 620 produces usage request 622, such as a call into an application programing interface (API) of a cloud provider management unit 638 at service tenancy 630.

In accordance with an embodiment, usage request 622 is a request to add a resource, such as a core, host, or virtual machine, to customer tenancy 602. Usage request 622 is a call into an API of cloud provider management unit 638 to add the resource to the customer tenancy 602. Alternatively, usage request 622 is any other type of message to the cloud computing system to add the resource to customer tenancy 602.

In accordance with an embodiment, cloud provider management unit 638 is used to manage customer networks at customer tenancies. The cloud provider management unit manages cloud network tenancies. The cloud provider management unit allocates resources within the cloud network for customer tenancies. Cloud provider management unit 638 also monitors resources within the cloud network. Cloud provider management unit 638 monitoring, billing and other management functions.

In accordance with an embodiment, service platform 672 provides shared services for administration of a cloud computing network. Service platform 672 enables centralized control and monitoring, ensuring that administrative tasks are streamlined and consistent across different environments.

In accordance with an embodiment, API gateway 674 processes and manages API calls from clients, such as usage request 622. API gateway 674 routes requests to appropriate services. API gateway 674 ensures secure communication by implementing authentication and authorization mechanisms. Rate limiting and throttling of API requests are enforced by API gateway 674 to prevent abuse and ensure fair usage. API gateway 674 provides logging and monitoring capabilities, capturing detailed metrics on API usage and performance. In one example, the API gateway 674 performs load balancing to distribute incoming requests evenly across multiple instances of a service. In one example, API gateway 674 is part of a service platform for the cloud computing system.

In accordance with an embodiment, quota service 676 enforces resource usage limits for users and customer tenancies. The system continuously monitors requests for cloud computing resources, comparing them against predefined quotas using quota service 676. By implementing these limits, the system prevents overconsumption of resources, ensuring fair distribution and optimal performance within the cloud environment. In one example, the usage request is API call to API gateway 674. The system transmits a threshold check request from API gateway 674 to quota service 676 to determine whether the threshold was exceeded. Quota service 676 receives the threshold check request, and the system's determination of the cloud computing usage increase value. Quota service 676 then determines whether the cloud computing usage increase value exceeds the threshold.

In accordance with an embodiment, cloud computing limit calculation unit 640 calculates limits for resource usage of customer tenancies. Cloud computing limit calculation unit 640 sets and enforces limits for various resources within the cloud infrastructure. Cloud computing limit calculation unit 640 allocates defined amounts of CPU, memory, and storage to different users and applications. Cloud provider management unit 638 monitors resource usage ensuring compliance with the predefined limits. When usage approaches the allocated limits, cloud computing limit calculation unit 640 issues alerts to notify users. To prevent overallocation and ensure fair distribution, cloud computing limit calculation unit 640 restricts resource access once limits are reached. Cloud computing limit calculation unit 640 logs instances where resource usage exceeds the set limits, providing a record for auditing and review. Cloud computing limit calculation unit 640 integrates seamlessly with billing systems, facilitating charges based on actual resource consumption.

In accordance with an embodiment, threshold calculation unit 650 calculates threshold 656 relative to a time frame, such as daily, for cloud computing limit calculation unit 640. Threshold 656 relates to a cloud computing usage increase value. For example, threshold 656 limits the amount of additional resources that can be consumed within a single day. When usage approaches the daily threshold, cloud provider management unit 638 triggers an alert. Cloud provider management unit 638 monitors daily usage increases to ensure compliance with the threshold. Upon reaching threshold 656, cloud provider management unit 638 restricts further resource allocation to prevent excessive consumption. Cloud provider management unit 638 logs all instances of threshold breaches, creating a record for audit purposes. In one example, threshold calculation unit 650 calculates threshold 656 as a function of the monthly usage limit 652 and/or fixed value 654. An exemplary threshold may be a maximum of a percentage the monthly usage limit 652 and the fixed value 654, such as the maximum of 10% of the monthly usage limit 652 and fixed value 654.

In accordance with an embodiment, cloud computing limit calculation unit 640 maintains table 642. Cloud computing limit calculation unit 640 updates table 642 as new computing resource requests 644 and deleted computing resource requests are received in the time period. In one example, entries in table 642 includes a timestamp, the type of change, and the amount of change.

In accordance with an embodiment, cloud computing limit calculation unit 640 uses the stored information from table 642 to calculate cloud computing usage increase value 660. In accordance with an embodiment, resources are associated with resource values. Cloud computing limit calculation unit 640 increments and decrements resource values from cloud computing usage increase value 660 within the time period. In one example, the resource values are cost estimates 658 that correspond to monetary values.

In accordance with an embodiment, cloud computing limit calculation unit 640 identifies when cloud computing usage increase value 660 exceeds threshold 656. In accordance with an embodiment, cloud computing limit calculation unit 640 generates remediation action 678 when cloud computing usage increase value 660 exceeds threshold 656. Exemplary remediation actions include rejecting the usage request, bypassing the threshold, and/or sending a warning message.

In accordance with an embodiment, billing unit 670 calculates charges based on resource usage. Billing unit 670 monitors consumption of CPU, memory, storage, and network bandwidth. Accurate usage data is recorded by billing unit 670 in real-time. Billing unit 670 generates invoices by applying predefined pricing models. In one example, cloud computing limit calculation unit 640 is separate from billing unit 670 so that the cloud computing limit calculation unit 640 is not limited by billing unit 670 before generating remediation action 678.

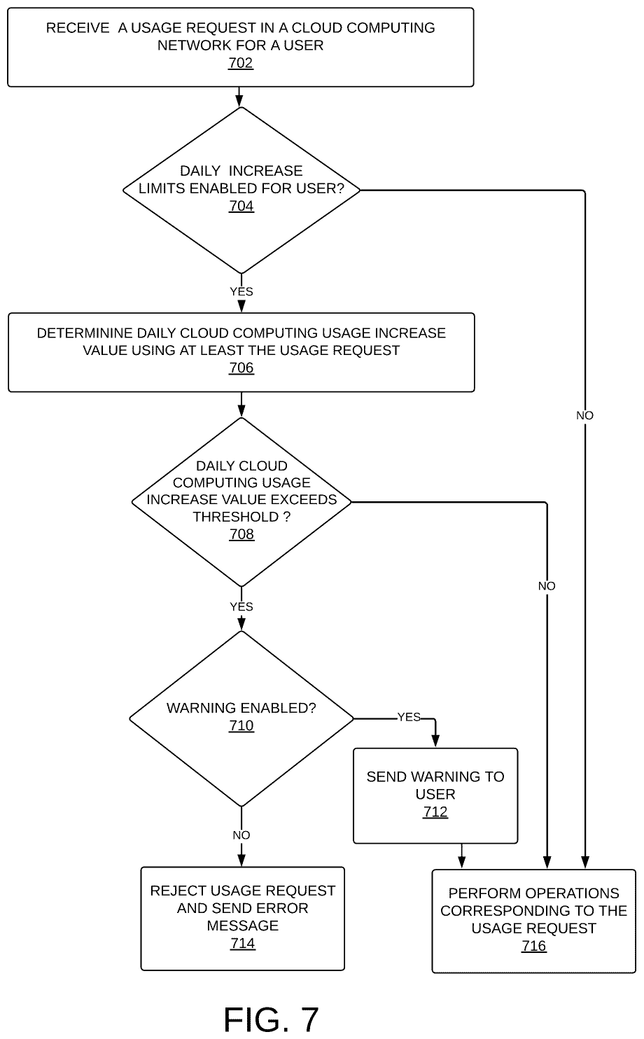

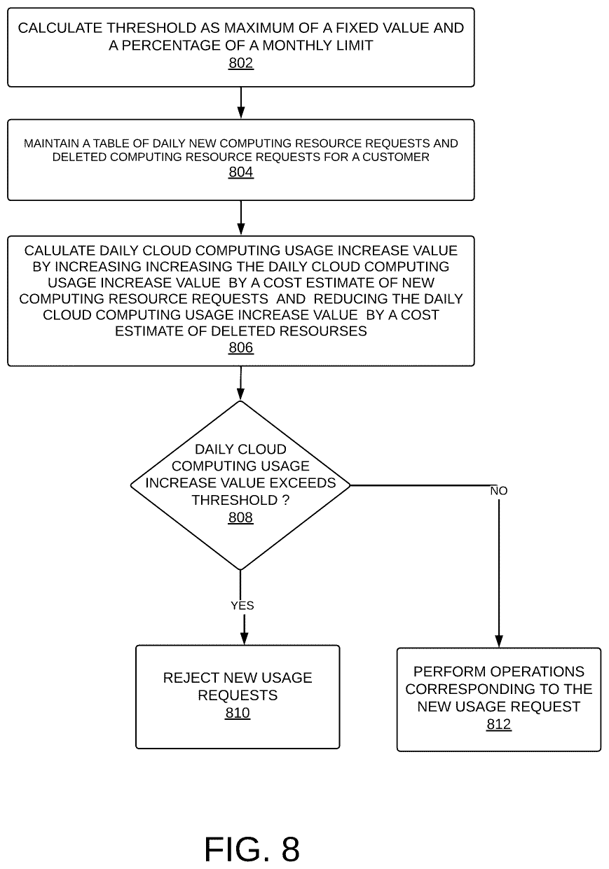

In one or more embodiments, customer tenancy 602, resources 604 including hosts 606A and 606B, cores 608A and 608B, virtual machines 610A and 610B, customer administrator device 620, .usage request 622, service tenancy 630, cloud provider management unit 638, cloud computing limit calculation unit 640, API gateway 674, threshold calculation unit 650, and billing unit 670 refers to hardware and/or software configured to perform operations described herein for usage limits in a cloud computing systems. Examples of operations for usage limits in a cloud computing system are described below with reference to FIGS. 7 and 8.

In an embodiment, customer tenancy 602, resources 604, service tenancy 630, cloud provider management unit 638, cloud computing limit calculation unit 640, threshold calculation unit 650, billing unit 670, service platform 672, quota service 676 and API gateway 674 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. Determining Remediation Action for Spending Limit Increase Enforcement

FIG. 7 illustrates an example set of operations for determining threshold for spending limit increase enforcement in accordance with one or more embodiments. One or more operations illustrated in FIG. 7 may be modified, rearranged, or omitted all together. Accordingly, the particular sequence of operations illustrated in FIG. 7 should not be construed as limiting the scope of one or more embodiments.

In an embodiment, the system receives a usage request for a cloud computing network for a customer (Operation 702). The usage request is for a new cloud computing resource in the customer tenancy, such as a core, host, or virtual machine. In one example, the system uses an Application Programming Interface (API) to facilitate communication between the clients and the cloud infrastructure. The API defines the protocols and conventions for interaction, ensuring that the resource requests conform to the system's specifications. Upon receiving a resource request, the cloud computing system parses the request to identify the necessary resources and their respective configurations. The system then processes the request through a series of predefined operations, which may involve resource allocation, provisioning, and deployment. In addition or as an alternative to the API, the cloud computing system employs other types of messaging to handle resource requests. Alternately, the messages include service calls, notifications, and/or event triggers.

In one embodiment, an application programming interface (API) gateway receives the usage requests for multiple cloud services in the cloud computing network. In one example, the usage request is an API call to the API gateway. The system transmits a threshold check request from the API gateway to a quota service to determine whether the threshold was exceeded. The quota service receives the threshold check request, and the system's determination of the cloud computing usage increase value and checks whether the usage increase value exceeds the threshold is performed by the quota service.

In an embodiment, the system checks if daily increase limits are enabled for the user. (Operation 704). The system identifies the customer tenancy associated with the incoming usage request. Following identification, the system accesses the configuration settings pertinent to the customer tenancy. The system examines these settings to determine the presence of daily increase limits. The system then retrieves relevant data from databases or configuration files that contain details of the daily increase limits.

In an embodiment, if daily increase limits are enabled, the system determines daily cloud computing usage increase value using at least the usage request (Operation 706). The system determines the daily usage increase value using a table of daily usage requests and resource deletions. The system receives and logs daily usage requests into a table. The system also logs resource deletions into the same table, ensuring comprehensive tracking of resource usage. The system processes the table to extract data relevant to the calculation of usage increase. The system identifies the total requested resources and their associated costs for a specific day by analyzing the logged usage requests. The system also identifies the total resources deleted on the same day and their associated costs. To determine the daily usage increase value, the system calculates the difference between the total requested resources and the total deleted resources, considering the associated costs, which may be monetary or non-monetary. In one embodiment, the system determines the cloud computing usage increase value outside of a billing system.

In one embodiment, the cloud computing usage increase value is calculated using a monetary cost estimate of the usage request, with the increase value representing an estimate of spending increase if the usage request is accepted. Alternatively, the system calculates the cloud computing usage increase value using a usage estimate of the usage request, representing an estimate of usage increase if the request is accepted.

In an embodiment, if daily increase limits are not enabled, the system performs the operations corresponding to the usage request (Operation 716). The system parses the request to determine the specific resources required, including their type, quantity, and configuration. The system accesses its resource inventory to check availability. If the requested resources are available, the system allocates them from its pool. The system then configures the allocated resources according to the parameters specified in the request. This configuration process involves setting up the necessary software, networking, and storage components to ensure the resources function as intended. After configuration, the system deploys the resources, making them accessible to the user or application that submitted the request. The system updates records to reflect the allocation and deployment of the resources, ensuring accurate tracking and management of resource usage.

In an embodiment, the system checks if daily cloud computing usage increase value exceeds a threshold (Operation 708). The system calculates the threshold or obtains the threshold from a stored value. In one example, the threshold is determined from a function such as a function of a fixed value and a monthly limit.

In one embodiment, upon determining that the cloud computing usage increase value exceeds the threshold, the system performs a remediation action. This remediation action involves either rejecting the usage request or bypassing the threshold.

In an embodiment, if the daily cloud computing usage increase value exceeds a threshold, the system checks if the system enables warning messaging for the user. (Operation 710). The system accesses configuration settings to determine whether warning messaging is enabled for the user. The system retrieves and examines the relevant user-specific or global settings that dictate the behavior of warning messages.

In an embodiment, if the daily cloud computing usage increase value does not exceed the threshold, the system performs the operations corresponding to the usage request as described above in operation 716.

If the system enables warning messaging for the user, the system sends a warning to the user (Operation 712). Upon determining that warning messaging is enabled, the system generates a warning message tailored to inform the user of the potential denial due to limit violations or other constraints. The system then performs the operations corresponding to the usage request as described above in operation 716.

If the system does not enable warning messaging for the user, the system rejects the resource usage request and send an error message (Operation 714). The system does not provide the requested resource to the user. The system generates an error message that details the reason for the rejection, citing the specific policy or condition that was not satisfied.

In one embodiment, the remediation action by the system includes bypassing the threshold and further determining a user session risk. The system performs bypassing the threshold in response to determining that the user session risk is lower than a risk threshold. The system determines the user session risk by evaluating the type of authentication performed for the user. The determination of user session risk involves assessing whether multi-factor authentication (MFA) was performed for the user. In one embodiment, if the user session risk for the current user session is deemed less risky, the threshold is temporarily increased so as to lessen the daily restriction. In one embodiment, the system allows the user to adjust the daily increase threshold or bypass a resource request rejection based on the user session risk.

### 6. Determining Threshold for Spending Limit Increase Enforcement

FIG. 8 illustrates another example set of operations for determining threshold for spending limit increase enforcement in accordance with one or more embodiments. One or more operations illustrated in FIG. 8 may be modified, rearranged, or omitted all together. Accordingly, the particular sequence of operations illustrated in FIG. 8 should not be construed as limiting the scope of one or more embodiments.

In an embodiment, the system calculates threshold as maximum of a fixed value and a percentage of a monthly limit. (Operation 802). The system first retrieves the fixed value from its configuration settings. Simultaneously, the system accesses the monthly limit associated with resource usage. The system then calculates a percentage of the monthly limit, applying a predetermined percentage value to the monthly limit to derive a calculated value. Following this calculation, the system compares the fixed value to the calculated value. The system determines the threshold by identifying the greater of the two values. By selecting the maximum value, the system establishes the threshold that will be used for subsequent evaluations of resource usage requests. Alternately, the system produces the threshold using other calculations.

In an embodiment, the system maintains a table of daily new computing resource requests and deleted computing resource requests for a customer (Operation 804). The system logs incoming resource requests into the table, recording details such as the type, quantity, and configuration of the requested resources. Similarly, the system logs resource deletions into the same table, capturing pertinent information about the resources being removed from the customer's allocation. The table is structured to include timestamps, user identifiers, and other relevant metadata to ensure comprehensive tracking and auditing. The system continuously updates the table in real-time, reflecting the latest additions and deletions as they occur. By organizing the data in this manner, the system enables efficient monitoring and analysis of resource usage patterns for the customer tenancy.

In an embodiment, the system calculates daily cloud computing usage increase value by increasing the daily cloud computing usage increase value by a cost estimate of new computing resource requests and reducing the daily cloud computing usage increase value by a cost estimate of deleted resources (Operation 806). The system uses the table of daily new computing resource requests and deleted computing resource requests to determine the cloud computing usage increase value. The system assigns a cost estimate based on predefined metrics, such as resource type, quantity, and usage duration for new computing resource requests. The system then adds this cost estimate to the current daily cloud computing usage increase value. The system also identifies deleted resources for the same period and assigns a cost estimate to these deletions. The system reduces the daily cloud computing usage increase value by this cost estimate of the deleted resources.

In an embodiment, the system checks if daily cloud computing usage increase value exceeds the threshold (Operation 808). If daily cloud computing usage increase value exceeds the threshold, the system rejects new usage requests (Operation 810). If daily cloud computing usage increase value exceeds the threshold, the system performs operations corresponding to the new usage request 812.

### 7. Practical Applications, Advantages & Improvements

Providing spending increase limits in a cloud computing network produces significant technical advantages. Such spending increase limits the expansion of resource usage at a customer tenancy of a cloud computing system may be due to errors or malicious agents, such as hackers. Undesirable resource usage in cloud computing systems results in energy wastage which is avoided using the spending increase limits. Energy wastage contributes to greenhouse gas emissions, exacerbating climate change. Spending increase limits allow tenants to have better control of expenses and to get early warnings of errors and malicious agents. Such early warnings allow the tenants to fix the errors and/or the block malicious agents. Malicious agents may compromise sensitive data, including personal information, financial records, and trade secrets. Infected systems can suffer data loss, system crashes, or unauthorized control by the attacker. Spending increase limits prevent such problems.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
receiving a usage request in a cloud computing network for a user, the user having a customer tenancy in the cloud computing network including cloud computing resources;
determining a cloud computing usage increase value relative to a time frame using at least the usage request;
determining whether the cloud computing usage increase value exceeds a threshold; and
based on determining that the cloud computing usage increase value exceeds the threshold, performing a remediation action comprising at least one of:
rejecting the usage request; and
bypassing the threshold.

2. The non-transitory media of claim 1, wherein the remediation action comprises bypassing the threshold and wherein the remediation action further comprises determining a user session risk, wherein bypassing the threshold is responsive to determining that the user session risk is lower than a risk threshold.

3. The non-transitory media of claim 2, wherein determining the user session risk comprises determining a type of authentication that was performed for the user.

4. The non-transitory media of claim 3, wherein determining the user session risk comprises determining whether multi-factor authentication (MFA) was performed for the user.

5. The non-transitory media of claim 1, wherein the remediation action comprises bypassing the threshold and wherein bypassing the threshold comprises performing an operation corresponding to the usage request.

6. The non-transitory media of claim 1, wherein the remediation action comprises bypassing the threshold and wherein bypassing the threshold further comprises sending an indication to the user that the cloud computing usage increase value exceeds the threshold.

7. The non-transitory media of claim 1, wherein the remediation action comprises bypassing the threshold and wherein bypassing the threshold comprises sending a request to the user to increase the threshold.

8. The non-transitory media of claim 1, wherein receiving the usage request is performed by an application programming interface (API) gateway for a plurality of cloud services in the cloud computing network and wherein the usage request is an API call to the API gateway.

9. The non-transitory media of claim 8, further comprising transmitting, from the API gateway to a quota service, a threshold check request to determine whether the threshold was exceeded, wherein the quota service receives the threshold check request and wherein determining the cloud computing usage increase value and determining whether the cloud computing usage increase value exceeds the threshold are performed by the quota service.

10. The non-transitory media of claim 1, wherein the cloud computing usage increase value is calculated using a cost estimate of the usage request and wherein the computing usage increase value is an estimate of a spending increase if the usage request is accepted.

11. The non-transitory media of claim 1, wherein the cloud computing usage increase value is calculated using a usage estimate of the usage request and wherein the computing usage increase value is an estimate of a usage increase if the usage request is accepted.

12. The non-transitory media of claim 1, wherein the usage request is a request for a new cloud computing resource in the customer tenancy, wherein the new cloud computing resource in the customer tenancy is a core, host, or virtual machine.

13. The non-transitory media of claim 1, wherein the threshold is calculated using a monthly usage limit.

14. The non-transitory media of claim 1, further comprising maintaining a table of new computing resource requests and deleted computing resource requests for the user, wherein the determining of the cloud computing usage increase value uses the table.

15. The non-transitory media of claim 1, wherein new resource creation requests increase the cloud computing usage increase value and new resource deletion requests decrease the cloud computing usage increase value.

16. The non-transitory media of claim 1, wherein the determining of the cloud computing usage increase value is done outside of a billing system.

17. The non-transitory media of claim 1, wherein the time frame of the cloud computing usage increase value is a single day.

18. The non-transitory media of claim 1, further comprising:
receiving a second usage request in the cloud computing network for the user;
determining a second cloud computing usage increase value using at least the second usage request;
determining whether the second cloud computing usage increase value exceeds the threshold; and
based on determining that the second cloud computing usage increase value is less than the threshold, performing an operation corresponding to the second usage request.

19. A method comprising:
receiving a usage request in a cloud computing network for a user, the user having a customer tenancy in the cloud computing network including cloud computing resources;
determining a cloud computing usage increase value relative to a time frame using at least the usage request;
determining whether the cloud computing usage increase value exceeds a threshold; and
based on determining that the cloud computing usage increase value exceeds the threshold,
performing a remediation action comprising at least one of:
rejecting the usage request; and
bypassing the threshold, wherein the method is performed by at least one device including a hardware processor.

20. A system comprising:
at least one device including a hardware processor;
the system being configured to perform operations comprising:
receiving a usage request in a cloud computing network for a user, the user having a customer tenancy in the cloud computing network including cloud computing resources;
determining a cloud computing usage increase value relative to a time frame using at least the usage request;
determining whether the cloud computing usage increase value exceeds a threshold; and
based on determining that the cloud computing usage increase value exceeds the threshold, performing a remediation action comprising at least one of:
rejecting the usage request; and
bypassing the threshold.
